(19) United States
(12) Patent Application Publication
(10) Pub. No.: US 2026/0298015 A1
(43) Pub. Date: Oct. 1, 2026

(54) METHOD FOR AUTOMATED CLOSING OF A SIDE DOOR OF A MOTOR VEHICLE

(71) Applicant: MERCEDES-BENZ GROUP AG, Stuttgart (DE)

(72) Inventor: Özgür MUTLU, Stuttgart (DE)

(21) Appl. No.: 19/477,968

(22) PCT Filed: Feb. 26, 2024
(86) PCT No.: PCT/EP2024/054820

§ 371 Date: Oct. 23, 2025

(30) Foreign Application Priority Data
Apr. 24, 2023 (DE) 10 2023 001 634.9

(51) Int. Cl. E05F 15/73; B60R 22/48; E05F 15/60

(52) U.S. Cl. CPC E05F 15/73; B60R 22/48; E05F 15/60; B60R 2022/4808; E05Y 2400/42; E05Y 2400/852; E05Y 2900/531

(57) ABSTRACT

A side door of a motor vehicle is automatically closed by a drive when it is recognized that a passenger has entered a passenger compartment of the motor vehicle. A radar sensor is used to recognize passenger entry.

### BACKGROUND AND SUMMARY OF THE INVENTION

Exemplary embodiments of the invention relate to a method for automated closing of a side door of a motor vehicle and to a motor vehicle which has an open-loop/closed-loop control device set up/programmed to carry out this method.

Modern motor vehicles are often equipped with a radar sensor arranged in the passenger compartment. With the aid of this radar sensor, it can be recognized whether a child is in the passenger compartment. If this is the case, and the motor vehicle is locked from the outside, an alarm signal can be output. In this manner, it is prevented that the child is unintentionally locked in the motor vehicle and left behind.

A motor vehicle having a radar sensor installed in the passenger compartment is known, for example, from DE 10 2019 211 192 A1.

Exemplary embodiments of the present invention are directed to new ways of developing motor vehicles having a radar sensor installed in the passenger compartment.

Therefore, the fundamental idea of the invention is to use a radar sensor—often already present as standard—in the passenger compartment of the motor vehicle to recognize that a passenger has just entered the passenger compartment. If, with the aid of the radar sensor, it is recognized that a passenger has reached the passenger compartment of the motor vehicle via an open side door of the motor vehicle, this side door is automatically closed after successful entry of the passenger into the passenger compartment, provided the side door has a controllable electrical drive. In this manner, the entry process is made significantly more comfortable for the passenger as manual closing of the door or manual triggering of an automatic closing process can be omitted.

The method according to the invention serves for automated closing of a side door of a motor vehicle. According to the method, a side door of the motor vehicle that can be adjusted between an open and a closed position by means of an electrical drive is adjusted into the closed position by means of the electrical drive when it has been recognized by means of at least one radar sensor present in the passenger compartment that a passenger has entered a passenger compartment of the motor vehicle when the side door was open.

In a preferred embodiment, the at least one radar sensor can be a UWB sensor (ultra-wideband sensor). This sends radar impulses into the passenger compartment, in order to detect in this manner whether a passenger is in the passenger compartment or even if they are moving, as is practically essential when entering the vehicle. Such a UWB sensor can thus detect the presence and in particular a forward movement of a passenger in the passenger compartment with extremely high reliability and precision. Such a radar or UWB sensor can have components known for this purpose, such as a system clock, pulse-wave generator, signal amplifier, transmitter, pulse receiver, wave displacement sensor.

According to an advantageous further development of the method according to the invention, after successfully adjusting the side door into the closed position, an—in particular acoustic and/or visual—information signal is output in the passenger compartment. In this manner, the vehicle occupant that has just entered the motor vehicle, but also the driver of the motor vehicle, can be informed that the side door has been successfully closed after successful entry.

According to another advantageous further development of the method according to the invention, when adjusting the side door into the closed position is unsuccessful, an—in particular acoustic and/or visual—warning signal is output in the passenger compartment. Adjustment into the closed position of the side door may, for example, have been blocked by an obstacle present in the door opening. This problem can be indicated with the aid of the warning signal to the passenger who has just entered, in particular however the driver of the motor vehicle, who can subsequently introduce corresponding measures to resolve the problem.

According to another preferred embodiment, it is conceivable that after entry of the passenger into the passenger compartment has been recognized, all side doors that are in the open position and have an electrical drive are automatically adjusted into the closed position. This measure puts the motor vehicle into a ready-to-drive state, at least concerning the position of the individual side doors.

According to a further advantageous further development, the motor vehicle comprises at least two side doors that can be adjusted by means of a respective electrical drive and close a respective door opening in the closed position. In this further development, it is detected by means of the radar sensor present in the passenger compartment through which door opening the passenger has entered the motor vehicle. After the passenger has entered the passenger compartment through the side door assigned to this door opening, this side door is adjusted into the closed position by means of the electrical drive. In this further development, it is therefore ensured that the side door that is adjusted into the closed position is the one through the assigned door opening of which the passenger entered the passenger compartment.

More preferably, adjusting the relevant side door into the closed position can only be initiated when it has been recognized by means of the radar sensor that the passenger has occupied a specific seat position after entering the passenger compartment. In this manner, the process of closing the side door is prevented from beginning prematurely, in particular too early. Therefore, in turn, the passenger is prevented in particular from being irritated or even injured when entering through the already closing side door.

According to a further advantageous further development of the method according to the invention, it is detected by means of a belt sensor present in the motor vehicle whether the passenger entering the motor vehicle has put on a seatbelt assigned to the seat position after occupying this seat position detected by means of the radar sensor, and if it has been recognized that this is not the case, an error signal is created after the side door is closed and the motor vehicle subsequently drives away. In particular, a warning signal can be output in the passenger compartment. In this manner, in addition to the automated closing of said side door, it can be ensured that the passenger who has entered the motor vehicle and is located in the passenger compartment—as usually required by law—has put on a seatbelt before the motor vehicle drives away.

Exemplary embodiments of the invention further relate to a motor vehicle having a passenger compartment.

The motor vehicle according to the invention further comprises at least one side door that can be adjusted by means of an electrical drive between an open and a closed position. In the closed position, the at least one side door closes a door opening assigned to this side doors. In the open position, the side door releases this door opening, so that a passenger can enter the passenger compartment through the door opening. The motor vehicle according to the invention further comprises at least one radar sensor, by means of which the presence of a passenger in the passenger compartment can be detected. Furthermore, the motor vehicle according to the invention comprises an open-loop/closed-loop control device connected to the radar sensor in a data-transmitting manner to receive sensor data. The open-loop/closed-loop control device is furthermore designed to adjust the at least one side door between the open and the closed state by means of the electrical drive. For this purpose, the side door can be controlled by means of the open-loop/closed-loop control device. Furthermore, the open-loop/closed-loop control device is set up/programmed to carry out the method according to the invention presented above. The advantages of the method according to the invention, explained above, are therefore transferrable to the motor vehicle according to the invention.

In a preferred embodiment, the motor vehicle according to the invention comprises at least one front side door and at least one rear side door, which in each case can be adjusted between the open and the closed position with the aid of an electrical drive. More preferably, a left front side door and such a right side door—each with an electrical drive—can be provided. Alternatively or additionally, a left rear side door and a right rear side door—each with an electrical drive—can be provided. In this embodiment, a first radar sensor is arranged in the passenger compartment, by means of which the presence of a passenger can be detected in a front interior region of the passenger compartment, which is accessible through a front left or front right door opening assigned to the front left or front right side door, respectively. Furthermore, in this embodiment, a second radar sensor is arranged in the passenger compartment, by means of which the presence of a passenger can be detected in a rear interior region of the passenger compartment, which is accessible through a rear left or rear right door opening assigned to the rear left or rear right side door respectively.

More preferably, the at least one radar sensor present in the passenger compartment is a UWB (ultra-wideband) sensor. More preferably, this can emit radar impulses into the passenger compartment and therefore detect whether a passenger is inside the passenger compartment, in particular is moving, as is practically essential when entering a vehicle. Such a UWB sensor can detect the presence and in particular movement of the passenger in the passenger compartment with maximum reliability and a high degree of precision. Such a radar or UWB sensor can have known components, such as a system clock, pulse-wave generator, signal amplifier, transmitter, pulse receiver, wave displacement sensor.

Further important features and advantages of the invention result from the dependent claims, the drawing and the associated figure description given with reference to the drawing.

It is understood that the aforementioned features and the features still to be explained in the following can not only be used in the respectively specified combination, but also in other combinations or in isolation, without leaving the scope of the present invention.

Preferred exemplary embodiments of the invention are represented in the drawing and are explained in more detail in the following description, wherein the same reference signs refer to identical or similar or functionally identical components.

### BRIEF DESCRIPTION OF THE SOLE DRAWING FIGURE

The sole drawing FIGURE shows, in a schematic illustration, an example of a motor vehicle 1 according to the invention in a plan view.

### DETAILED DESCRIPTION

The motor vehicle 1 illustrated in the sole drawing FIGURE comprises a passenger compartment 2 surrounded by a car body 8. Furthermore, the motor vehicle 1 comprises a front left side door 4a, a front right side door 4a, a rear left side door 4b and a rear right side door 4b. All four side doors 4a, 4b can be adjusted between an open and a closed position by means of a respective electrical drive 7a or 7b, which is known by the person skilled in the art under the name Door Mover. In the closed position, the respective side door 4a, 4b closes a door opening 5a or 5b of the motor vehicle 1, assigned to this side door 4a, 4b. In the open position, the respective side door 4a, 4b releases the door opening 5a, 5b assigned to it, so that a passenger (not shown) can get into the motor vehicle 1 or its passenger compartment 2 through this door opening 5a, 5b.

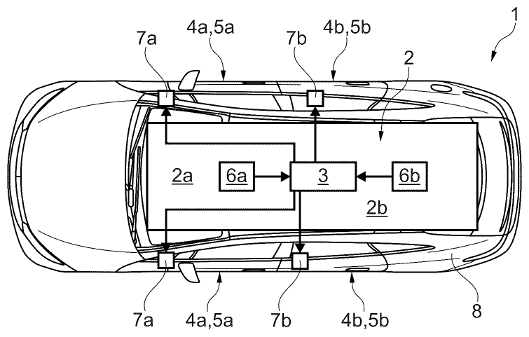

In the example scenario, the motor vehicle 1 further comprises a first radar sensor 6a and a second radar sensor 6b, which are both arranged in the passenger compartment 2. The presence of a passenger (not shown) can be detected in a front interior region 2a of the passenger compartment 2, accessible through one of the two front door openings 5a, by means of the first radar sensor 6a. For this purpose, the first radar sensor 6a, as shown in FIG. 1, can be arranged particularly expediently in the front interior region 2a. For the arrangement of the first radar sensor 6a in the passenger compartment 2, other suitable positions (not shown in in the sole drawing FIGURE) are also conceivable.

The presence of a passenger can be detected in a rear interior region 2b of the passenger compartment 2, accessible through both rear door openings 5b, by means of the second radar sensor 6b. For this purpose, the second radar sensor 6a, as shown in the sole drawing FIGURE, can be arranged particularly expediently in the rear interior region 2b. For the arrangement of the second radar sensor 6b in the passenger compartment 2, other suitable positions (not shown in the sole drawing FIGURE) are also conceivable.

Both radar sensors 6a, 6b can be designed as UWB sensors.

Furthermore, the motor vehicle 1 according to the invention comprises an open-loop/closed-loop control device 3 connected to the two radar sensors 6a, 6b in a data-transmitting manner to receive sensor data. The open-loop/closed-loop control device 3 is furthermore designed to adjust the four side doors 4a, 4b between the open state and the closed state by corresponding activation of their electrical drive 7a and 7b, respectively. Furthermore, the open-loop/closed-loop control device 3 is set up/programmed to carry out the method according to the invention, which is explained by way of example in the following.

According to the method, a side door 4a or 4b that is in the open position is adjusted into the closed position by the open-loop/closed-loop control device 3 by means of its electrical drive 7a or 7b, respectively, when it has been recognized by one of the two radar sensors 6a, 6b present in the passenger compartment 2 and it has been transmitted to the open-loop/closed-loop control device 3 that a passenger has entered the passenger compartment 2 through the door opening 5a, 5b assigned to the side door 4a, 4b when this side door was open.

In one variation of the example, adjusting the relevant side door 4a, 4b into the closed position is only initiated after it has been recognized by means of the radar sensor 6a, 6b that the passenger has occupied a specific in the passenger compartment 2.

Optionally, after successfully adjusting the side door 4a, 4b into the closed position, a—for example acoustic or visual—information signal can be output in the passenger compartment 2. Similarly, when adjusting the relevant side door 4a or 4b into the closed position is unsuccessful, optionally a—for example acoustic or visual—warning signal can be output in the passenger compartment 2.

Optionally, it is conceivable in the example scenario that after the entry of the passenger has been recognized, all side doors 4a, 4b that are in the open position and have an electrical drive 7a, 7b are adjusted into the closed position.

In a further development variation of the example, it can be checked by means of a belt sensor present in the motor vehicle 1 whether the passenger, after occupying the seat position detected by the radar sensor, has put on a seatbelt assigned to this seat position. If it is recognized that this is not the case, in this variation an error signal can be created after successful closing of the side door 4a, 4b and after the motor vehicle 1 drives away following the closing of the side door 4a, 4b. In particular, a—for example acoustic or visual—warning signal can be output in the passenger compartment 2.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method comprising:
determining that a side door of a motor vehicle is in an open position;
determining, while the side door is in an open position and using a radar sensor, that a passenger entered a passenger compartment of the motor vehicle; and
initiating automatic adjustment, responsive to the determination that the passenger entered the passenger compartment while the side door is in the open position, of the side door from the open position into a closed position.

12. The method of claim 11, further comprising:
outputting, subsequent to the automatic adjustment of the side door into the closed position, an information signal in the passenger compartment.

13. The method of claim 11, further comprising:
outputting, in the passenger compartment, a warning signal responsive to the side door not being successfully moved into the closed position.

14. The method of claim 11, wherein the motor vehicle comprises a plurality of additional side doors, and wherein the initiating the automatic adjustment of the side door further comprises automatically adjusting side doors of the plurality of side doors that have an electric drive and are in the open position into the closed position.

15. The method of claim 11, wherein
the side door is a first side door of the motor vehicle and the motor vehicle comprises a second side door that is adjustable by a respective electrical drive between the open and closed positions,
the radar sensor detects through which door opening the passenger has entered the motor vehicle,
the first or second side door assigned to the detected door opening is adjusted into the closed position by the respective electrical drive after the passenger enters the vehicle.

16. The method of claim 11, wherein the initiating automatic adjustment of the side is performed subsequent to the radar sensor detecting that the passenger has occupied a specific seat position in the passenger compartment.

17. The method of claim 11, further comprising:
detecting, using a belt sensor in the motor vehicle, that the passenger has not put on a seatbelt assigned to a specific seat position after occupying the specific seat position seat position; and
outputting, responsive to the detecting that the passenger has not put on the seatbelt and that the motor vehicle is driving away after successfully closing the side door, a warning signal.

18. A motor vehicle comprising:
a passenger compartment;
at least one door opening;
at least one side door configured to close the at least one door opening when the at least one side door is in a closed position and the side door opens the door for passenger entry into the passenger compartment when the at least one side door is in an open position;
an electric drive coupled to the at least one side door and configured to move the at least one side door between the open position and the closed position;
at least one radar sensor configured to detect presence of the passenger in the passenger compartment; and
an open-loop/closed-loop controller, coupled to the at least one radar sensor, configured to adjust the at least one side door between the open position and the closed position by
determining that the at least one side door of a motor vehicle is in the open position;
determining, while the at least one side door is in an open position and using the at least one radar sensor, that the passenger entered the passenger compartment of the motor vehicle; and
initiating automatic adjustment, responsive to the determination that the passenger entered the passenger compartment while the at least one side door is in the open position, of the at least one side door from the open position into the closed position.

19. The motor vehicle of claim 18, wherein
the at least one side door comprises the motor vehicle comprises at least one front side door and at least one rear side door,
the at least one door opening comprises a first door opening and a second door opening, the at least one front side door covering the first door opening in the closed position of the at least one front side door and the at least one rear side door covering the second door opening in the closed position of the at least one rear side door,
the at least one radar sensor comprises a first radar sensor arranged in the passenger compartment to detect presence of a passenger in a front interior region through the at least one front door opening and a second radar sensor arranged in the passenger compartment to detect presence of a passenger in a rear interior region accessible through the rear door opening.

20. The motor vehicle of claim 18, wherein the at least one radar sensor is a UWB sensor.
